(19) United States
(12) Patent Application Publication
(10) Pub. No.: US 2005/0063574 A1
(43) Pub. Date: Mar. 24, 2005

(54) Method and computer program for digital image processing for two-dimensional electrophoresis

(76) Inventors: Anders Heyden, Dalby (SE); Lars Malmstrom, Seattle, WA (US); Johan Malmstrom, Lund (SE); Ola Forsstrom-Olsson, Lund (SE); Magnus Per Berglund, Lund (SE)

Correspondence Address: LADAS & PARRY LLP, 224 SOUTH MICHIGAN AVENUE, SUITE 1200, CHICAGO, IL, 60604, US

(21) Appl. No.: 10/500,985

(22) PCT Filed: Jan. 10, 2003
(86) PCT No.: PCT/SE03/00029

Related U.S. Application Data
(60) Provisional application No. 60/350,252, filed on Jan. 15, 2002.

(30) Foreign Application Priority Data
Jan. 11, 2002 (SE) 0200072-7

(51) Int. Cl. G06K 9/00; G06K 9/32

(52) U.S. Cl. 382/128; 382/294

(57) ABSTRACT

Method for processing digital image data for a two-dimensional array of sample substance spots and marker substance spots in an electrophoresis gel by using landmark substances having predefined properties, comprising the steps of:generating an ideal image represented by co-ordinate data corresponding to ideal positions of the marker substance spots in said array dependent on electrophoresis conditions; generating a marker image represented by co-ordinate data corresponding to detected positions of said marker substances spots in the array; determining a mathematical relation between the ideal image and the marker image, such that the co-ordinate data of said images are mapped onto each other; generating a sample image represented by a sample image data set corresponding to detected signal values in the gel; and normalising the sample image by transforming it dependent on said mathematical relation.

### FIELD OF THE INVENTION

The present invention relates to methods and devices for digital image processing of biological sample separations. More specifically it relates to techniques for processing digital image data for a two-dimensional array of sample substance spots and marker substance spots in an electrophoresis gel by image normalisation.

### BACKGROUND OF THE INVENTION

In a cell obtainable from e.g. a cell culture or tissue sample an existing pool of proteins, a proteome, exists as a part of biological processes and functions. In many different clinical, diagnostical and analytical situations it is desirable to gain knowledge about the identity and amount of a protein or a group of proteins at a certain point in time, and also of certain changes over time. Certain biological processes are defined by changes in morphology and physiology due to changes in the expression, i.e. the protein level, of particular genes. Also, developmental stages of cells can be defined and monitored by their global pattern of gene expression and the progressive changes that occur over time of particular genes or groups of proteins. Even more, as a response to treatment of cells with chemical factors, e.g. drugs, hormones, nutrient factors, environmental factors and other growth condition factors, specific proteins of groups of proteins can change their expression and as such allow for monitoring or identifying a response or treatment. Information of this type can be used to e.g. detect, identify and classify tumours in terms of malignancy, evaluation of therapies, adjustment of therapies as well as diagnosis and prognosis. Also, changes in proteins due to mutations, cleavage, phosphorylation or glycosylation can be obtained. Further identification of unknown proteins can e.g. be done by mass-spectrometry of unidentified sample protein spots on the gel.

A general method used for detecting, identifying, monitoring and quantifying the compositions of complex biological mixtures is two-dimensional gel electrophoresis. In such a method the separation performed in two dimensions enables detection and identification of a large number of components that would not be separable and distinguishable in a one-dimensional separation, such as a linear separation. A frequently used method for monitoring the protein expression by 2D (two-dimensional) gel electrophoresis comprises the feature of analysing a set of multiple gels in one run.

A typical prior art method is detection and identification of sample spots in a 2D polyacrylamide gel. By using large gels, the number of proteins to be detected and identified can be several hundred up to about 10 000 in one gel. Each spot is detected by means of a signal derived from the individual spot. In a typical gel size of 24×18 cm, several thousands of sample protein spots are detected. Normally, about 10% of the total number of sample spots need to be selected as so-called landmarks. After a separation process has been performed, the spatial relation between these landmarks, or markers, and the sample spots is measured and used for the purpose of identification of the sample substances, in a manner well known to the skilled person. This further involves a few hundred manually selected landmarks in each gel. The process of detection, identification and analysis of the separate components in a two-dimensional electrophoresis gel is a complex and difficult task, and often involves tedious and time consuming manual steps demanding months of experience to perform. Several attempts have been made to develop means and methods to simplify, standardize and automise the procedure as described in Smilansky et al., 2001, Electrophonesis 22: 1616-1626; Thompson et al., 1998, in 20^{th} Annual International Conference of the IEEE Engineering in Medicine and Biology Society, Vol. 20: 1060-1063; Wanatabe, et al., 1998, in 20^{th} Annual International Conference of the IEEE Engineering in Medicine and Biology Society, Vol. 20:804-808.

The manner in which the sample protein spots are distributed across the two-dimensional gel-electrophoresis depend on the separation parameters used in the first and second dimension in the two-dimensional electrophoresis procedure. Two parameters commonly used are isoelectric point and molecular size (Gorg et al., 2000, Electrophoresis 21:1037-1053). Furthermore, various ways of obtaining detectable signals from the spots have been used, such as post-gel colouring techniques, e.g. silver staining as described in Sinha et al., 2001, Proteomics 1:853-840; Shevchenko et al., 1996, Anal. Chem. 68:850-858. Other techniques that are used include optical density, radioactive emission, fluorescence emission, and calorimetric signals (Pavon et al., 1999, J Interferone Cytokine Res.19:589-599; Steinberg et al., 2001, Proteomics, 1:841-855; Herich et al., 2001, Biotechniques, 31:146-149; Kemper at al., 2001, Electrophoresis, 22:970-976; Lauber et al., 2001, Electrophoresis 22:919-932; Berggren et al., 2000, Electrophoresis 21:2509-2521; Steinberg et al., 2000, Electrophoresis 21:486-496). Detection of the spots is commonly achieved by the use of imaging devices that convert the detected signals into digital data and store the data as information on computer storage media.

One of the key features in identifying the sample spots is the assignment and use of reference spots known as “landmarks”. The landmarks are actual protein spots that are manually selected by the user, i.e. manual landmarking. Computer software is further used for processing the manually selected spots in order to automatically detect and identify the same spots in all of the member gels in one matchset. These user-selected landmarks are preferably relatively few in number compared to the total number of sample spots in an individual electropherogram. The selection criteria of the manual landmarks are that the spots should be well-resolved, that they are well isolated from other spots, and that they appear in all the gels of the matchset. The number of spots to be assigned as landmarks must be large enough that all of the remaining protein spots among the various gels will be successfully matched by the automatic processing. The function of the landmarks is to serve as guideposts in the gel-to-gel comparison, thereby aiming at reducing and compensating differences and distortions among the member gels in the matchset to assure that there will be a proper correspondence of protein spots among different gels in the matchset.

Further, by using known sample proteins manually chosen as landmarks in the 2-DE one has to consider only proteins that exists in all gels in one matchset. Such protein must exist in a relatively large amount to be readily repeatable and detectable in all of the gels. Due to this, the spots chosen as protein landmarks are often large and blob-like. This gives less defined landmarks that are difficult to position accurately, i.e. to find the exact centre of the landmark, which is a source of inaccuracy on the analysis process of the sample protein spots.

The process of selecting and marking spots to be used as landmarks is slow and tedious, and is one of the limiting factors in two-dimensional gel electrophoresis analysis. Normally, since about 10% of the total number of protein spots needs to be selected as protein landmarks to make the image analysis algorithm work correctly, several hours must be used for each run to pick said landmarks manually. Also, in addition to assigning the above described selection criteria for manually chosen landmarks, the time involved in making the selections and making the spots adds to the cost and time involved in performing the analysis. Even further, the level of user involvement raises question regarding reproducibility and reliability.

Being a generally known and widely used technique, the state of the art comprises several disclosures relating to two-dimensional electrophoresis.

U.S. Pat. No. 5,139,630 teaches a method for detecting and identifying protein species in a, sample by capillary zone electrophoresis by the addition of at least two external markers, one being an ionic species and one being a neutral charged species. This method is only applicable for capillary electrophoresis, i.e. where the separation is in one dimension, here disclosed for charge densities, and not applicable for a separation using more than one dimension as in e.g. a two-dimensional gel electrophoresis.

WO 01/07920 discloses a method for automated landmarking for two-dimensional gel electrophoresis by the addition of marker proteins to the sample proteins. However, the use of proteins as external landmarks has several disadvantages, such as high production costs and short shelf life of the final protein product. Further, the use of protein landmarks, means that special means have to be taken to make such proteins visualized in contrast to proteins present in a sample material.

U.S. Pat. No. 5,073,963 teaches an interactive computerized method for matching visual patterns of polypeptide spots in two-dimensional (2-D) gel electrophoresis. The computerized method manipulates spot pixel coordinates using staged coordinate transformation techniques on spot markers and unknown study spots to reduce gel preparation distortions and allows a user to produce matching results in a manner that compares the transformed spot data using either a single, reference gel or multiple reference gels approach for producing the matching results. Dominant sample spots are selected as marker spots, on which transformation is based.

In the light of the aforementioned problems it is thus an object of the invention to provide means and methods for reducing time and cost relating to the process of electrophoresis. An aspect of this object is to increase the reproducibility and reliability of two-dimensional gel electrophoresis used for separation, detection, identification and quantification of proteins, and to provide a solution overcoming the problems associated with the prior art means and methods.

### SUMMARY OF THE INVENTION

In order to fulfil the objects above, the present invention provides a method for using detected signals from externally added markers, having known properties, in order to transform a detected 2D gel image to a form in which it is comparable to other images of 2D gels. In particular, the present invention makes use of non-protein markers, more specifically markers selected from dendrimers.

The method according to the present invention is defined in the appended claims.

Needless to say, this method can be used to compare plural gels, two by two. Since the markers are selected and have known properties, this transformation and subsequent comparison can be performed completely automatic for two or more gels, saving hours of work which as such constitutes a potential source of manual errors.

### BRIEF DESCRIPTION OF THE DRAWINGS

The features of the present invention will be described in more detail below by means of preferred embodiments and examples, with reference being made to the appended drawings, in which

FIG. 1 schematically illustrates a grid of co-ordinates relating to ideal positions of landmark spots in an electrophoresis gel for given electrophoresis conditions, according to an embodiment of the invention;

FIG. 2 schematically illusions a grid of co-ordinates relating to the detected positions of landmark spots in an electrophoresis gel for said given electrophoresis conditions, according to an embodiment of the invention;

FIG. 3 schematically illustrates an image comprising the sample spots of the same electrophoresis gel, according to an embodiment of the invention,

FIG. 4 schematically illustrates a normalised image of the sample image in FIG. 3, according to an embodiment of the invention;

FIG. 5 schematically illustrates how a dendrimers may be built up according to an embodiment of the invention;

FIG. 6 shows formulas from which a dendrimers core may be selected in embodiments of the invention;

FIG. 7 illustrates an example of a di aminobenzoic acid as a core in an embodiment of the invention; and

FIG. 8 illustrates examples of monomers with monovalent and divalent branching units, according to embodiments of the invention.

### DETAILED DESCRIPTION OF PREFERRED EMBODIMENTS

As revealed above, the present invention relates to the method of using external markers in a gel electrophoresis process for normalising images from 2-D gels, making it possible to match sample spots between different images from 2-D gels, and to quantify sample spots in images from 2-D gels, in a more effective way than with the prior art techniques.

Once a electrophoresis separation process has been performed on a gel comprising sample substances and landmark substances, these substances will be gathered in spots dependent on their properties, wherein each spot, or the centre thereof, corresponds to a certain parameter value pair in the two dimensions. The resulting pattern of spots will hence form a 2D array of more or less discrete spots. A suitable technique for capturing an image of this pattern is subsequently used, such that signals from the spots in the array are detected. Preferably the image is captured by scanning, but may also be captured by a single shot. The position of the landmark spots is then determined from the captured image. By using a digital scanner, the capturing of the image and the determination of the landmark spot positions may be performed in essentially the same step. From a single shot image, the spot positions may be determined by subsequent scanning of that image.

In order to detect the landmark spots, i.e. the positions of the landmark spots in the captured image, it is advantageous if the landmark substances are easily distinguishable from the sample substances. As described below this can be achieved in various ways. A suitable algorithm preferably is used to determine the co-ordinates for the centre of the spots for preferably all landmark spots in the gel. A data set of pairs of co-ordinates is thus formed, a detected landmark data set, representing signals in a detected image in an actual electrophoresis case. Each co-ordinate pair of the detected landmark image refers to a certain parameter value pair in the two dimensions of the 2D electrophoresis. One example of a landmark image, wherein the detected positions for the landmark spots are indicated, is shown in FIG. 2.

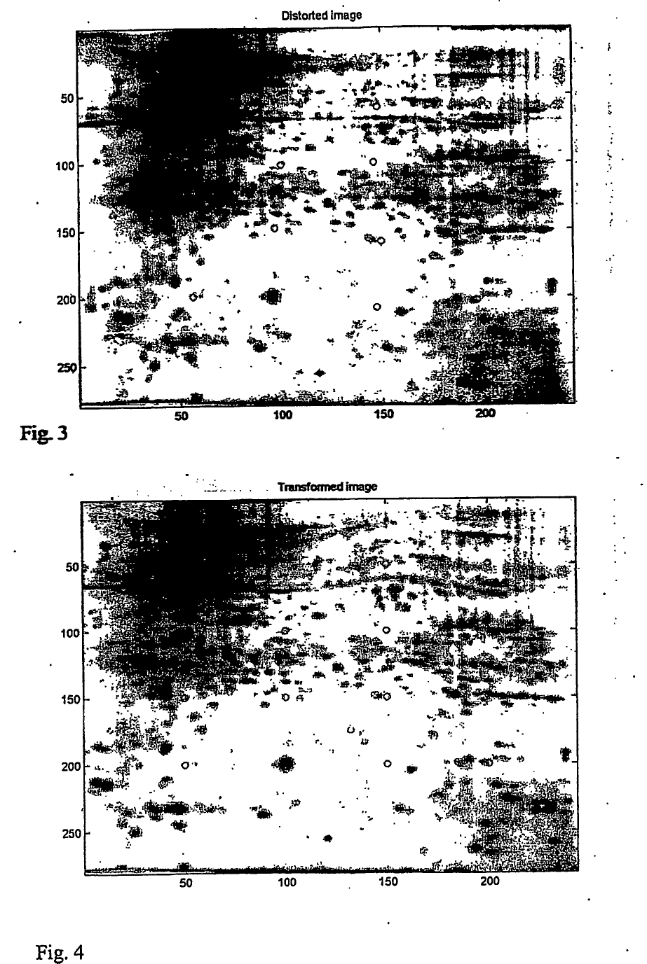

Furthermore, a sample image is formed by capturing an image of the gel in which the sample spots are detected. As a person skilled in the art will realise, the landmark image and the sample image may be derived or formed from the same captured image, or from successive captured images. The sample image is digitally represented by a sample image data set comprising a signal value for each pixel in the captured sample image, or global image. This global image may or may not include the landmarks. Preferably, said signal value is expressed as a level of magnitude in a scale, such as a grey scale, relating to the exposure of the image in that particular pixel. An example of a sample image of a separated electrophoresis gel is shown in FIG. 3, corresponding to the landmark image of FIG. 2.

For different reasons, such as inconsistencies in the gel, the landmark substances in an actual electrophoresis run will rarely be located as would be expected from their known properties and the chosen electrophoresis conditions. This is one of the reasons why simple direct comparison between two electrophoresis cases is not always reliable, since this uncertainty naturally is equally valid for the sample substances.

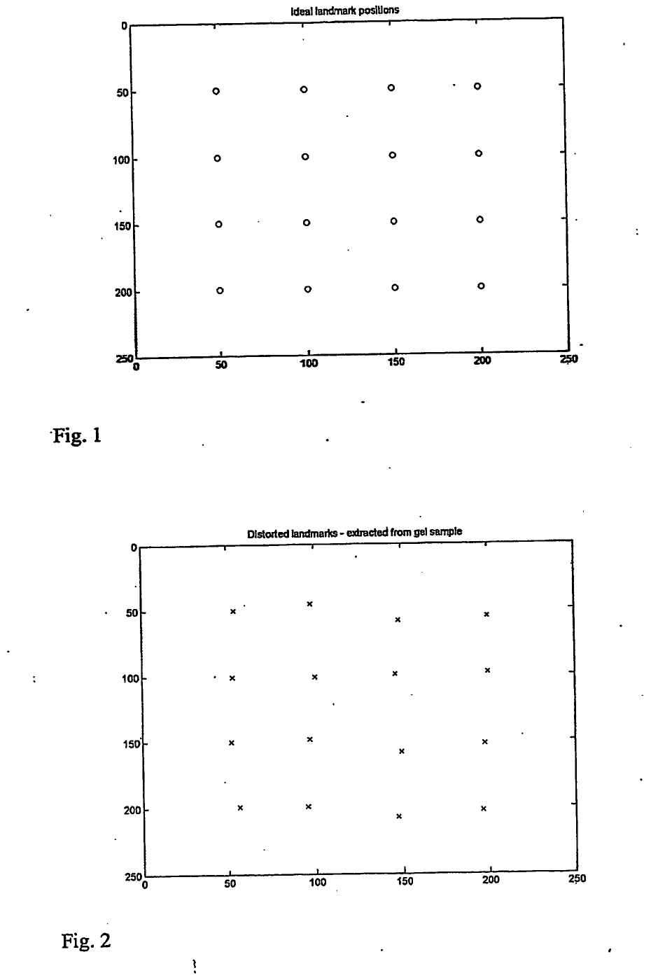

According to the invention, this problem is overcome by transforming the global image such that the external landmarks are positioned in the co-ordinates to which their properties in the separation processes correspond. This way, two or more electrophoresis gels ran under the same conditions may be independently transformed into a reference format, such that they may be compared to each other. The transformation feature of the invention is based on usage of known landmarks. One feature of using landmarks selected from substances of known properties is, that when the conditions of the separation process of the electrophoresis are known; also the expected positions which these marker substances would ideally assume in the gel are known, or can be derived. By said conditions is here meant for instance the type, e.g. isoelectric point and molecular size, and range of parameters used to separate the samples in the gel, and the type of gel used. Consequently, once a set of landmark substances is chosen and certain electrophoresis conditions are selected, a pattern of discrete co-ordinates corresponding to the positions those landmark substances would assume, based upon their properties, can be derived. Accordingly, a data set of pairs of reference co-ordinates is thus formed, here denoted a reference landmark data set, representing signals in a reference image or ideal image relating to an ideal electrophoresis case. Each co-ordinate pair of the reference image refers to a certain parameter value pair in the two dimensions of the 2D electrophoresis. An example of an ideal marker image, corresponding to the landmark image derived from the detected landmarks as shown in FIG. 2, is illustrated in FIG. 1. By comparison between these two figures it will be obvious that the positions of the corresponding markers do not coincide perfectly.

In order to be able to perform the aforementioned transformation, a mathematical relation between the reference landmark data set and the detected landmark data set is determined, such that the co-ordinates of the landmarks, or markers, in the two images represented by said data sets, i.e. the reference image and the detected landmark image, are mapped onto each other. The mathematical relation for this mapping is calculated from the position differences between corresponding co-ordinate pairs in the respective sets, but at the same time the mathematical relation is continuous for the entire reference image.

Each pixel of the transformed image is then created by collecting the value for the 5 corresponding pixel in the detected global image according to the following basic procedure. A first pixel in the image plane of the reference image is mapped by said mathematical relation into the image plane of the detected global image. If th. J'lobal image is distorted compared to what would have been expected under the present conditions, the co-ordinates of the mapped pixel will not be the same as the original pixel in the reference image plane. Once the mapped pixel co-ordinates have been calculated, the signal value of that co-ordinate is read in the sample image data set, and that signal value is thereafter assigned to said first pixel in the reference image plane. Each part of the reference image plane is then built up pixel by pixel to form a complete transformed image of the detected global image. Consequently, the entire detected image of samples is transformed by this mapping. The detected image is then globally transformed. An example of a such a globally transformed, normalised, image is illustrated in FIG. 4. In fact the image in FIG. 4 is transformed from the detected sample image of FIG. 3, using a mathematical relation derived from the relation between the ideal and detected landmark images of FIGS. 1 and 2, respectively, in accordance with an embodiment of the invention. All electrophoresis test items separated by this specific type of gel and strip, and having the corresponding set of landmarks, will in this globally transformed format have their landmarks placed on exactly the same positions or co-ordinates. A specific example of determining a mathematical relation for mapping the landmark images onto each other is described further below.

In a preferred embodiment of the invention, external landmarks are used. Preferably these external landmarks are artificial molecules which are not proteins, as disclosed in the related patent application SE 0103103-8, which is the priority document of WO 03/025581. Several technical effects are obtained by the invention. The analysis of the detected image is automised in a higher degree than in the prior art solutions. By adding external knowledge, i.e. substances of known properties, the time-consuming manual placing of landmarks in the image, which is also a potential source of errors, in order to obtain a match with another image, is eliminated. Instead, each image is independently processed into a format in which it is comparable with any other processed image carrying the same landmarks.

Using selected artificial landmarks further brings¹about the effect that landmark substances can be selected such that they form a desired pattern over the image, e.g. with substantially equal distance between each neighbouring landmark spots, resulting in a more even accuracy over the entire image and a more accurate transformation. The proteins functioning as landmarks in the prior art are spatially rather undefined and differing from time to time, which results in an uncertainty in the positioning in the landmarks from a spot. Detection of the artificial landmarks is more secure since the same amount of a certain landmark substance is always selected, wherein the spot will essentially always look the same. Therefore, the algorithm used will determine the co-ordinates in essentially the same way each time, rendering a more accurate positioning.

According to an embodiment of the invention, the marker compounds suitable for gel electrophoresis are added externally, and are not chosen from the samples, as revealed above. The marker compound may be a polymer or it may be selected from the group consisting of glycoconjugates, carbopeptoides, polynucleotides, proteoglycanes, fullerenes, carbohydrates and mixtures thereof.

In specific embodiments, the marker compound is characterised by a pI of about 2-12. In still further embodiments, it is characterised by a pI of about 3-10.

Further embodiments include marker compound characterised by a Mw of about 5-10⁶Da. In still even further embodiments, the Mw may be of about 10³-10⁵ Da, 5-1000 Da, 5-600 Da, 5-250 Da or an otherwise suitable interval of molecular size due to the size of the samples to be separated and detected. Specific embodiments comprise marker compounds characterised by a pI of about 1-12 and by a Mw of about 100-10⁶.

In one embodiment the marker compound is a dendrimers. Dendrimers are built up from different structural building blocks, some that may include branching points to achieve a tree like structure characteristic for dendrimers. The different building blocks are coupled together to achieve said treelike structure.

The dendrimers offer two important features when used as marker molecules, namely a) the size can be easily modified by adding more layers and b) the feature of the dendrimeric compounds can be modified by adding different functional groups to the layers. Since the individual building blocks may be composed of repeatable units, the dendrimers molecule may be built up from only a few numbers of coupling steps, which is economically and technically advantageous.

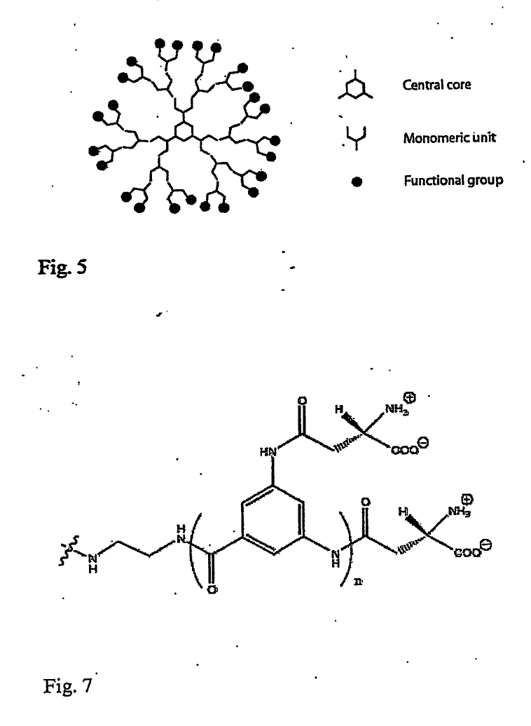

According to the invention, the dendrimers may comprise at least one monomer, at least one functional group and optionally at least one core as building blocks. The dendrimers may be built up from separate building blocks as shown in FIG. 5, which is identical with FIG. 2 in the patent application SE 0103103-8 referred to above. Said dendrimers may be built up either by a divergent strategy or by a convergent strategy as known in the art of dendrimers synthesis.

In one embodiment, the dendrimers to be used as external landmarks according to the invention is synthesised according to the divergent strategy.

The dendrimers may be represented by the general formula
(core)ₙ(monomer_{1 . . . o})ₓ (functional group _{1 . . . p})
wherein n is an integer from 0-5 representing number of different co-existing optional cores,
wherein o is an integer from 2-1000 representing number of different monomer building blocks within the monomer distributed over x layers,
wherein x is an integer from 1-20 representing number of layers, and
wherein p is an integer from 1-20 representing the number of different functional groups within one functional group building block.

Other suitable dendrimers to be used as landmarks according to the invention are commercially available dendrimers. Though, such dendrimers lack at least one functional group according to the invention. Such a functional group may then, of course, be coupled onto the commercially available dendrimers using techniques known to the skilled man in the art. Examples of, but not limited to, commercially available dendrimers that may be used according to the invention are Astramol™ (DSM Agro, The Netherlands) and Starbust® (Aldrich).

In specific embodiments of the invention, synthetic amino acid dendrimers will be used. In still a specific embodiment, a diamin or a triamin is used as a core, di aminobenzoic acid as a monomer and aspartic acid as a functional group. By introducing different numbers of di aminobenzoic acid as a monomer a huge range of molecular masses may be achieved as exemplified in the table below.

Molecular size of dendrimers made of a diamin as core building block, di aminobenzoic acid as a monomer (mon) and aspartic acid as a functional group.

| mon | Molecular size |
|---|---|
| 0 | 290 |
| 1 | 788 |
| 2 | 1785 |
| 3 | 3779 |
| 4 | 7767 |
| 5 | 15743 |
| 6 | 31694 |
| 7 | 63597 |

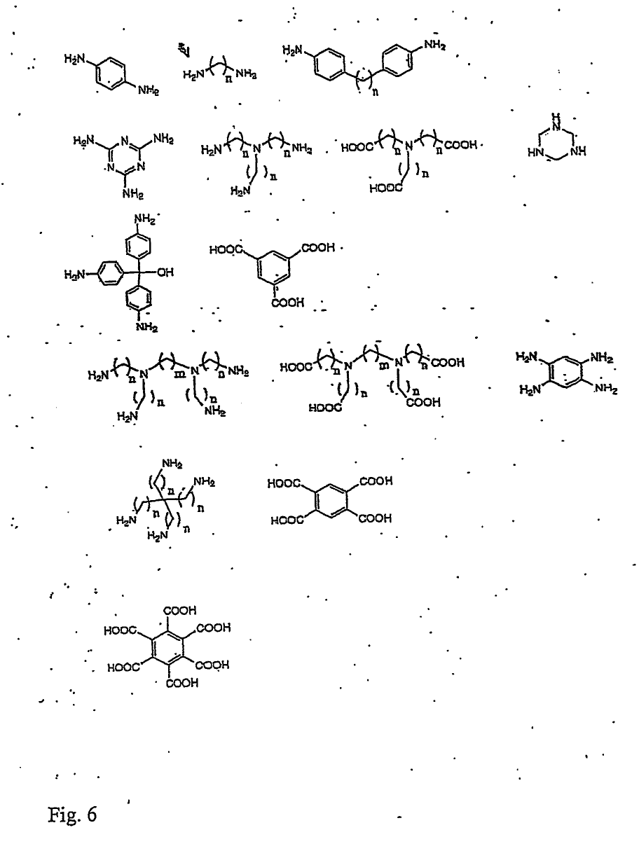

The dendrimers may comprise at least one core. According to specific embodiments, the core may include divalent, trivalent, tenement, multivalent cores and mixtures thereof. According to the invention, the at least one core may be selected from the group consisting of the formulas in FIG. 6, which is identical to FIG. 3 of SE 0103103-8, and mixtures thereof.

In one embodiment, the core may be a diamine where n=2 or a triarnine where n=1.

The core may contain further branching units, allowing the treelike structure characteristic of the dendrimers to form.

An example of a dendrimers uses diaminoethane as the core.

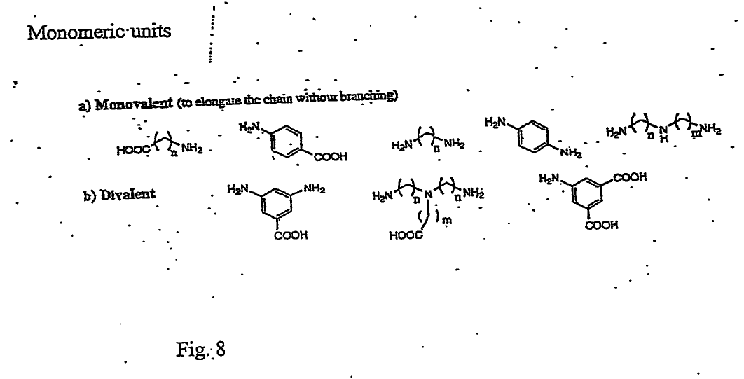

The dendrimers also comprises at least one monomer. The monomer may include further branching possibilities to the dendrimers molecule to achieve the treelike structure characteristic of the dendrimers. Due to the numbers of branching possibilities, the monomer may be monovalent, i.e., to elongate without branching, divalent, trivalent, tetravalent, multivalent or mixtures thereof. Examples of such monomers with monovalent and divalent branching units are shown in FIG. 8, which is identical to FIG. 5 of SE 0103103-8.

Specific embodiments use amid bondings between the different monomers.

In still a further embodiment, the at least one monomer may be 3,5- diaminobenzoic acid, as shown in figure is shown in FIG. 7, which is identical to FIG. 4 of SE 0103103-8. The number of monomers will contribute to the final molecular size of the dendrimers. According to specific embodiments, using 3,5- diaminobenzoic acid as monomer the monomer may be in a number of 1-10.

The dendrimers may also contain a functional group according to the invention. The at least one functional group will to the dendrimers add known characteristics. An example of known characteristics is, e.g. a desired net charge to the molecule.

In specific embodiments, at least one functional group may be added to the free ends generated in the coupling step. Due to the addition of the at least one functional group, the landmark will according to the invention be able to position in the gel if the gel parameters used for separation are selected so as to enable separation of the marker compound characteristics.

According to different embodiments the at least one functional group may be selected from the group of zwitterions, anionic or cationic, oligopeptides, alcohols, tiols, carboxy acids, amines; fluorochromes, such as fluorescamine, isotopes and mixtures thereof. In a specific embodiment, the fluorescamine used is the commercially available Fluram® available from Molecular Probes, U.K. In still further specific embodiments, the at least one functional group is selected from the group consisting of an amino acid such as aspartic acid, glutamic acid.

According to the invention, the marker compound has known characteristics affecting its migration in a gel during gel electrophoresis so as to position the marker compound in said gel. Such characteristics may, of course, be included by the addition of a functional group to the dendrimers. Even further, it may reflect the molecular size of the marker compound.

By selecting landmarks with chosen characteristic, such as, e.g. pI and molecular size values, the external added landmarks may position in a desired way over the gel. Such information about characteristics of the external markers may be used for further analysis of unknown samples; such as unknown proteins.

According to the invention, a set of marker substances may form at least two marker spots in a gel after an electrophoresis run. As such, these spots will appear in different areas in the gel, due to the known characteristics of the marker compounds that form said spots, separated in at least one dimension. The number of marker spots may differ. This is due to the large number of different types of gels to be used in the gel electrophoresis step. Another factor that may affect the number of markers needed are the number of sample spots on the gel, which is obvious for the skilled man in the art of gel electrophoresis and separation of samples such as e.g., protein samples. Other factors that affect the number of spots needed are the number of separation dimensions. The invention is applicable to electrophoresis separation in at least one dimension and preferably two, but may be applied in separation in more than two dimensions. The number of marker spots needed may therefore be, such as about 0-50% of the number of sample spots, preferably 1-20%, e.g. 1-10% of the number of sample spots. Specific embodiments of the invention may use marker spots, wherein the at least two marker spots may be from about 2-1000 marker spots per said gel. In still further embodiments, the at least two marker spots may be from about 2-500, 10-250, 10-100, or about 20-40 marker spots per gel. In an embodiment of a two dimensional gel, e.g. a polyacrylamid gel, in a size of about 24×18 cm, the number of marker spots needed may be about 9-40, e.g. 9-16 marker spots.

The grid formed by the distributed marker spots in the gel may be spatially even, but the marker set may also be selected such that the marker spots will appear unevenly distributed for various reasons. One such reason may be that is known or suspected beforehand that certain sample substances will be present in the gel and will gather in a specific region of the gel. It may then be desirable to select markers which will equally be gathered in the vicinity of this region, in order to have a sufficient amount of landmark readings in this region in order to improve the sample quantification accuracy.

The marker spots appearing in a gel will contain different number of marker compounds per marker spot. However, the amount of marker compounds should be enough to allow a clear and concise detection of the marker spot on the gel. This is, of course, dependent on how the sample spots are detected, equipment and/or gel resolution.

According to specific embodiments of the invention, at least two marker compounds are used forming at least two marker spots which may position in the gel at ideal positions. As used herein, the word ideal is intended to mean ideal due to empirical information, such as experimental data, or from theoretical information, such as chemical and/or physical data characterising the marker compounds used. Such compounds may be designed to be dependent upon e.g. pI and molecular size for their positioning. Of course the marker compounds may be designed in different ways, as obvious to the skilled man in the art, to depend upon other characteristics for separation according to other dimensions than pI and molecular size. The set of external landmarks may in specific embodiments comprise at least two marker compounds forming at least two spots, wherein the at least two marker compounds are characterised by a pI of about 1-12, such as about 3-10. In still further embodiments, the at least two marker compounds may be characterised by a Mw of about 100-10⁶, such as about 10³-10⁵. Specific embodiments of the invention may include two marker compounds characterised by a pI of about 1-12 and a Mw of about 100-10⁶.

The application of a set of marker or landmark substances or compounds in a gel may include applying the set in the form of application strips or mixing and applying the set together with the test samples, or applying the set at the time of casting of the gel.

When an electrophoresis separation has been made and the sample and marker substances have been positioned into spots in the gel, information about, the position of each separated marker compound needs to be collected and stored. This information may be collected using any of the determination processes selected from a group comprising visual light, UV, IR, multispectral imaging, isotope labelling, colouring techniques such as silver staining, Comassie staining, and fluorescence techniques. The external marker substances are preferably selected such that they are distinguishable from the sample spots in the gel. This may be achieved by using marker substances having optical properties different from the optical properties of the sample spots, making it possible to detect the external markers in the gel. The marker spots are preferably detected by scanning the gel and picking up signals representing the positions of the spots using any of the techniques in the aforementioned group. The scanning procedure results in a digitized image, which is stored in a data memory.

The stained gels, both containing separated landmarks and sample molecules, may be scanned in a scanner with dual detection possibility. With dual detection possibility, it is intended to mean that the scanner has the possibility to detect signals from different staining techniques, such as silver staining, fluorescent staining, radioactivity, or any other staining method used. In one embodiment, the landmarks are detected in a separate image, the marker image, after a scanning step, enabling detection of the landmarks positions only. Without changing the position of the gel, the parameters of the scanning apparatus are changed, so as to enable a separate scanning and detection of the separated sample molecules, e.g. the proteins, in order to register a sample image. The two gel images, one with the separated landmarks and one with the separated sample proteins, now collected in digitalized form, are subsequently used for the image analysis of the gel. The gel may also be scanned once, detecting the sample molecules and the proteins in one image. This may be convenient when the same detection methodology is used for the sample molecules and the landmarks, but when the optical and/or the geometrical properties of the marker spots and the sample spots allow differentiation between them.

The marker image is used for extraction of the co-ordinates for the spots of external markers in the image. This is done by standard techniques in mathematical imaging, and any of a number of methods could be used. The result is a file consisting of data representing the co-ordinates from the detected external markers in the gel. In accordance with the invention, the properties of the external markers according to the two separation parameters are known. For the set of external markers added to the sample prior to the electrophoresis a file of those properties has been established and stored in a file on a computer readable storage media, such as a -hard drive, a CD-ROM or other data storage device. The differences between the known properties and the observed positions of the external markers in the gel are subsequently used to construct a mathematical relation mapping the one set of data onto the other. The relation should due to obvious reasons be injective and continuous over the whole defined image area. This mathematical relation could be defined and/or determined in any of a number of ways. The result is a mathematical function mapping the existing, detected, image of the sample spots, or the sample spots plus the marker spots, onto another image, the “globally transformed image”. Below, one example of an embodiment for carrying out the invention is described with reference to the accompanying drawings.

A silver stained gel formed in an electrophoresis separation process is placed in a scanner and scanned in two different ways, or in a way that allows differentiating the marker spots from the sample spots, in order to extract the co-ordinates for the spot positions of the selected marker substances. The co-ordinates could typically be determined using segmentation of the marker spots, e.g. by using Watershed algorithm. A modified Gaussian distribution model of the marker spots may further be used to locate the centre of gravity for the spots and use the projection onto the x-y surface as the coordinates for the spots. The co-ordinate data thus extracted is stored in a file. The file of data for the set of detected spots of landmarks substances used in the image, and the file of the properties of said landmark-substances, are loaded into a computer carrying a computer program devised in accordance with the invention. The computer program now has access to the observed data and the “known” data relating to the landmarks. The known data on file may be specifically stated in the format of parameter pairs relating to the separation process used, but may also be stored in a form from which this value pair may be calculated dependent on electrophoresis conditions.

The co-ordinates for the ideal landmark positions are defined and accessible in the computer program as vectors named Pₓ and P_{y}. The co-ordinates for the detected landmark positions are defined and accessible in the computer program as vectors Vₓ and V_{y}. The x and y relate to the x-coordinates and the y-coordinates of the respective positions.

Using the Pₓ and the P_{y}, all distances between the landmarks in the image plane of the sought normalised image are calculated and stored in a vector r. A function U(r)=r²*log r² is then calculated for all the r's, and stored in a matrix K. This matrix is thus a n*n matrix over the n landmarks in the following manner:

$$K = [ \begin{matrix}0 & U ( {r}_{12} ) & … & U ( {r}_{1 n} ) \\ U ( {r}_{21} ) & 0 & … & U ( {r}_{2 n} ) \\ … & … & … & … \\ U ( {r}_{n1} ) & U ( {r}_{n2} ) & … & 0\end{matrix} ] .$$

A matrix P is constructed:

$$P = [ \begin{matrix}1 & {x}_{1} & {y}_{1} \\ … & … & … \\ 1 & {x}_{n} & {y}_{n}\end{matrix} ] ,$$

that is a 3*n matrix: [1 PₓP_{y}].

Then a matrix or operator L is constructed according to:

$$L = [ \begin{matrix}K & P \\ {P}^{T} & 0\end{matrix} ] , ( n + 3 ) * ( n + 3 ) ,$$

where P^{T} is the:transpose of the P matrix and 0 is a 3*3 matrix of zeros.

Let V=(v₁, v₂, . . . , Vₙ) be any n-vector, and write Y=(V|0 0 0)^{T}, a column vector of length n+3. A vector W=(w₁, w₂, . . . , wₙ) and coefficients a₁, aₓ, a_{y} are then defined by the equation L⁻¹Y=(W|a₁ aₓ a_{y})^{T}. According to the invention the elements of L⁻¹Y are subsequently used to define a function f(x,y) everywhere in the plane:

$$f ( x , y ) = {a}_{1} + {a}_{x} * x + {a}_{y} * y + {\sum }_{i = 1}^{n} {w}_{i} U ( \vert {P}_{i} - ( x , y ) \vert ) .$$

The function f is divided into two parts: a sum of functions U(r) and an affine part. Let

$$V = [ \begin{matrix}{x}_{1}^{′} & {x}_{2}^{′} & … & {x}_{n}^{′} \\ {y}_{1}^{′} & {y}_{2}^{′} & … & {y}_{n}^{′}\end{matrix} ]$$

where each landmark homologous to (xᵢ, yᵢ) in another copy of R². Here, R represents the real numbers, and consequently R² represents the real number pairs in the plane.

The application of L⁻¹ to the first column of V^{T} specifies the coefficients of 1, x, y, and the U's for fₓ(x,y), the x-coordinate of the image of (x, y); the application of L⁻¹ to the second column of V^{T} does the same for the y-coordinate f_{y}(x,y). The resulting function f(x,y)=[fₓ(x,y), f_{y}(x,y)] is now vector-valued: it maps each point (xᵢ, yᵢ) to its homolog (xᵢ′, yᵢ′). Furthermore, this function is the least bent of all such functions, according to the measure I_{f}, integral quadratic variation over all R², computed separately for real and imaginary parts of f and summed. These vector-valued functions f(x,y) are the thin-plate spline mappings used in this method. If the pairings of points between the sets is in accordance with biological homology, the function f models the comparison of biological forms as a deformation. The whole procedure is obviously invariant under translation or rotation of either set of landmarks. :

The application of L⁻¹ to both the columns of V^{T} thus specifies the coefficients for the transform between the to sets of landmarks. The coefficients are stored in the matrix “koeff”.

The coefficients are now applied to all the pixels in the sought normalized image, pixel-by-pixel, and the corresponding pixel value in the distorted image is determined.

For this calculated pixel in the distorted image, the grey-level (0-255) is determined. To determine the grey-level for a non-integer pixel value, some sort of interpolation can be used. In our example a discrete bi-linear interpolation is used. The grey-level thus determined are appointed to the pixel in the sought normalized image.

The next pixel in the sought normalized image is handled in the same way. In cases where the transform is mapping the pixel in the sought image to a pixel-value outside the defined area in the distorted image, the pixel in the sought image is set to 0 (black).

When all pixels are transformed, and appointed a grey-level, the sought image is created and can be plotted and handled as a new image, corrected according to the information from the pair of landmark sets.

Each point in the sought normalized image plane is mapped by a function
(x,y)→(x′, y′)=(x+fₓ(x,y),y+f_{y}(x,y)),
where the fₓ and f_{y} are the function based on Σ(−1)^{k}U(|(x,y)−Dₖ|) as viewed in 3 dimensions.

Although several examples of embodiments have been described a person skilled in the art will realise then further modifications are possible within the scope of the appended claims.

1. Method for processing digital image data for two-dimensional arrays of sample substance spots and marker substance spots in a plurality of electrophoresis gels, comprising the steps of:
combining, for each gel, a sample with a plurality of artificial external marker substances selected from dendrimers, each such marker substance having known predefined properties;
performing two-dimensional electrophoresis on each of said gels;
generating, for each electrophoresis gel, a digital image represented by a marker image data set comprising coordinate data and signal values corresponding to detected positions and signal values of said marker substance spots, and a sample image data set comprising coordinate data and signal values corresponding to detected positions and signal values of said sample substance spots;
processing said digital images to determine a mathematical relation between the coordinate data of said marker image data sets such that corresponding marker substance spots in said plurality of gels are mapped on each other;
transforming the coordinate data of said sample substance spots according to said mathematical relation.

2. The method as recited in claim 1, wherein said plurality of artificial external marker substances of dendrimers comprise added functional groups, determining net charge of the respective marker substance.

3. The method as recited in claim 2, wherein said plurality of artificial external marker substances of dendrimers comprise at least one monomer, determining molecular weight of the respective marker substance.

4. The method as recited in claim 1, wherein the step of determining said mathematical relation comprises the steps of:
defining ideal image data for each gel, comprising coordinate data corresponding to ideal positions of the marker substance spots in said array dependent on electrophoresis conditions and marker substance characteristics; and
determining a mathematical relation calculated from position differences between the coordinate data of corresponding marker substance spots of the ideal image data and detected marker substance spots, which mathematical relation includes a vector-valued function that, for each gel, transforms the coordinate data of the detected positions of marker substance spots to the coordinate data of the corresponding ideal positions of said marker substance spots
wherein the step of transforming the coordinate data of said sample substance spots comprises the steps of
for each gel, transforming the coordinate data of said sample substance spots to an ideal image plane by means of the determined mathematical relation.

5. The method as recited in claim 1, wherein the step of determining said mathematical relation comprises the steps of:
determining a mathematical relation calculated from position differences between the coordinate data of corresponding marker substance spots of detected positions of said marker substance spots in a first of said plurality of gels and in a second of said plurality of gels, which mathematical relation includes a vector-valued function that transforms the coordinate data of the detected positions of marker substance spots of said first gel to the coordinate data of the corresponding detected positions of marker substance spots of said second gel.

6. Method according to claim 1, wherein the electrophoresis gels contain a plurality of sets of, in relation to each other distinguishable, sample substances such that a plurality of sample images for each electrophoresis gel is acquirable.

7. Method according to claim 1, wherein the step of generating said sample image comprises the step of scanning the array to form a pixel image, and wherein the step of transforming the sample image data signals comprises the step of transforming every pixel of said sample image into a transformed image, dependent on said mathematical relation.

8. Method according to claim 6, wherein said array comprises two different marker substances having different properties, from which different properties coordinate data relating to ideal marker spot positions differing in at least one dimension for given electrophoreses operating conditions can be calculated.

9. Method according to claim 6, wherein said array comprises a plurality of different marker substances having different properties, from which different properties co-ordinate data relating to ideal marker spot positions differing in two dimension for given electrophoreses operating conditions can be calculated.

10. Method according to claim 9, wherein, dependent on the electrophoreses operating conditions, a set of marker substances is selected, comprising said plurality of different marker substances, dependent on their corresponding co-ordinates of in the ideal image data.

11. Method according to claim 4, wherein the step of transforming the coordinate data of said sample substance spots comprises the process steps of:
selecting a first pixel in an image plane defined by said ideal image data;
mapping said first pixel to the sample image;
reading the detected signal value for the mapped first pixel;
assigning said detected signal value to said first pixel in the image plane of the ideal image data; and
repeating these process steps for each pixel in the image plane.

12. Method according to claim 11, wherein the step of reading the detected signal value for the mapped first pixel comprises the step of:
establishing a detected signal value for the mapped first pixel dependent on the signal value of at least one pixel in the sample image adjacent the mapped first pixel.

13. Method according to claim 4, wherein the step of transforming the coordinate data of said sample substance spots comprises the process steps of:
selecting a first pixel in the sample image;
reading the detected signal value for said first pixel;
mapping said first pixel to the image plane defined by said ideal image data; assigning said detected signal value to the mapped first pixel in the image plane of the ideal image data; and
repeating these process steps for each pixel in the sample image.

14. Method according to claim 4, wherein the step of transforming the coordinate data of said sample substance spots comprises the process steps of:
selecting a first pixel in the image plane defined by said ideal image data;
reading the detected signal value for the mapped first pixel;
mapping said first pixel to the sample image;
assigning said detected signal value to said first pixel in the image plane of the ideal image data; and
repeating these process steps for pixels in the image plane defining an object consisting of sample substance spots and/or marker substance spots.

15. Method according to claim 4, further comprising the steps of:
determining the signal value for a first pixel in the ideal image plane dependent on the signal value of at least one mapped pixel in the ideal image plane adjacent said first pixel in the ideal image plane; and
repeating this determination process for each pixel in the ideal image plane.

16. Method according to claim 1 wherein the detection of positions and signal values of the marker spots is done by monitoring the shapes of the marker spots, both in two and three dimensions.

17. Method according to claim 1 wherein the detection of positions and signal values of the marker spots is done by monitoring the pattern(-s) of the marker spots in the gel.

18. Method according to claim 1 wherein the detection of positions and signal values of the marker spots is done by monitoring a combination of both shapes and pattern(-s) of the marker spots in the gel.

19. Method according to claim 1 wherein the detection of positions and signal values of the marker spots is done by monitoring the positions of the marker spots in the gel.

20. Method according to claim 1 wherein the detection of positions and signal values of the marker spots is done by monitoring a combination of both shapes and positions of the marker spots in the gel.

21. Method according to claim 1 wherein the detection of positions and signal values of the marker spots is done by monitoring a combination of both positions and pattern(-s) of the marker spots in the gel.

22. Method according to claim 1 wherein the detection of positions and signal values of the marker spots is done by monitoring a combination of shapes, pattern(-s) and positions of the markers spots in the gel.
